(19) United States
(12) Patent Application Publication
(10) Pub. No.: US 2013/0304544 A1
(43) Pub. Date: Nov. 14, 2013

(54) Fuel price activation and management system

(71) Applicants: Linda Carolyn Gillis, Douglas, GA (US); Anita Faith Coates, Douglas, GA (US)

(72) Inventors: Linda Carolyn Gillis, Douglas, GA (US); Anita Faith Coates, Douglas, GA (US)

(21) Appl. No.: 13/986,524

(22) Filed: May 10, 2013

Related U.S. Application Data
(60) Provisional application No. 61/645,629, filed on May 11, 2012.

(51) Int. Cl. G06Q 30/02

(52) U.S. Cl. CPC G06Q 30/0206
USPC 705/7.34

(57) ABSTRACT

A computer implemented method and system provides a fuel price management server (FPMS) for managing actions associated with fuel prices, and a fuel price activation system (FPAS). The FPMS is accessible by multiple user devices and fuel stations at multiple geographical locations via a network. The FPAS communicates with the FPMS and one or more display units positioned at each fuel station via the network. The FPMS dynamically acquires and sorts the fuel prices based on geographical locations via the network. The FPMS selectively transmits the sorted fuel prices to the FPAS at each fuel station via the network based on their geographical location. The FPAS performs actions at each fuel station based on the selectively transmitted fuel prices, for example, dynamically activating and displaying the fuel prices on the display units, scheduling refueling of fuel tanks, transmitting notifications on a low fuel price to user devices, etc.

### CROSS REFERENCE TO RELATED APPLICATIONS

This application claims the benefit of provisional patent application No. 61/645,629 titled “Fuel Price Activation And Management System”, filed on May 11, 2012 in the United States Patent and Trademark Office.

The specification of the above referenced patent application is incorporated herein by reference in its entirety.

### BACKGROUND

Fuel pricing is a criterion that retailers use to gain market advantage and to set fuel prices at a fuel station in anticipation or response to changing fuel prices. Typically, websites that provide fuel price information either send their employees to manually collect the prices or depend on volunteers manually relaying the information. The challenges that retailers face in making the right fuel pricing decisions often stem from inaccurate, fragmented, or excessive information. To improve pricing decisions and to gain a market advantage, there is a need for a fuel price activation and management system that acquires relevant information from a centralized system as well as from competitive market information in order to determine fuel prices in line with the goals of a retailer and perform one or more actions based on the fuel prices.

Fuel stations at different geographical locations typically do not have real time access to variations in fuel prices at those geographical locations and therefore cannot accurately update and display the fuel prices in real time. There is a need for a fuel price activation and management system that dynamically and accurately updates fuel prices at fuel stations at different geographical locations. Furthermore, there is a need for a fuel price activation and management system that performs multiple actions at a fuel station based on the dynamically updated fuel prices, for example, scheduling a refueling of fuel tanks at the fuel stations based on the fuel prices, transmitting alert notifications to frequently visiting customers at a particular fuel station informing them about low fuel prices, etc.

Hence, there is a long felt but unresolved need for a computer implemented method and system that manages actions associated with fuel prices at multiple fuel stations by managing changes in the fuel prices across different geographical locations, acquiring and sorting the fuel prices based on the geographical locations of the fuel stations, dynamically activating and displaying optimized fuel prices at the fuel stations based on their geographical locations, and performing multiple actions at each of the fuel stations based on the acquired fuel prices.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated needs for managing actions associated with fuel prices at multiple fuel stations by managing changes in the fuel prices across different geographical locations, acquiring and sorting the fuel prices based on the geographical locations of the fuel stations, dynamically activating and displaying optimized fuel prices at the fuel stations based on their geographical locations, and performing multiple actions at each of the fuel stations based on the acquired fuel prices. As used herein, the term “fuel station” refers to a facility, for example, a filling station, a gas station, a fueling station, a petrol pump, etc., that sells fuel, for example, gasoline including different grades of gasoline, kerosene, diesel oil, etc.

The computer implemented method and system disclosed herein provides a fuel price management server and a fuel price activation system. The fuel price management server comprises at least one processor configured to manage actions associated with the fuel prices. The fuel price management server is accessible by multiple user devices, for example, mobile phones, tablet computing devices, personal digital assistants, etc., and fuel stations at multiple geographical locations via a network. As used herein, the term “geographical locations” refers to locations within an a predefined area, for example, locations within the United States such as New York, San Francisco, Chicago, etc., and locations across the world, for example, locations such as New York, Paris, Sydney, etc. The fuel price activation system is provided at each of the fuel stations. The fuel price activation system comprises at least one processor configured to communicate with the fuel price management server and one or more display units positioned at each of the fuel stations via the network. As used herein, the term “display unit” refers to an output device, for example, a monitor, a display board, a console, a graphical user interface, etc., that displays information, for example, fuel prices at fuel stations for viewing by users.

The fuel price management server dynamically acquires the fuel prices associated with the geographical locations in real time via the network, for example, from stock price systems, supply and demand systems, etc. The fuel price management server sorts the dynamically acquired fuel prices based on the geographical locations. The fuel price management server selectively transmits the sorted fuel prices to the fuel price activation system at each of the fuel stations via the network based on the geographical locations of the fuel stations, for enabling the fuel price activation system to perform one or more actions at each of the fuel stations via the network based on the selectively transmitted fuel prices. In an embodiment, the fuel price management server computes a target fuel price for a selected geographical location based on the dynamically acquired fuel prices associated with multiple geographical locations and transmits the target fuel price to the fuel price activation system at the selected geographical location via the network. As used herein, the term “target fuel price” refers to a suitable fuel price for a fuel station at a particular geographical location, computed or selected based on the dynamically acquired fuel prices associated with multiple geographical locations. In another embodiment, the fuel price management server generates a list of selective sorted fuel prices based on a query request received from each of one or more user devices through a graphical user interface (GUI) provided by the fuel price management server via the network.

In an embodiment, the fuel price management server determines fuel suppliers at multiple geographical locations that provide fuel at low fuel prices. The fuel price management server determines proximity of each of the fuel stations to each of the geographical locations of the determined fuel suppliers. The fuel price management server determines freight charges involved in transporting a low cost fuel to fuel tanks at each of the fuel stations from the geographical locations of the determined fuel suppliers based on the determined proximity of each of the fuel stations to each of the geographical locations of the determined fuel suppliers. The fuel price management server then computes a resultant fuel price for each of the determined fuel suppliers by adding the low fuel prices provided by each of the determined fuel suppliers and the determined freight charges. The fuel price management server generates and transmits a list of the determined fuel suppliers and the computed resultant fuel price associated with each of the determined fuel suppliers to the fuel price activation system at each of the fuel stations via the network. The fuel price activation system at a fuel station selects one of the determined fuel suppliers that provides the low cost fuel at the lowest computed resultant fuel price from the list and schedules delivery of the low cost fuel to the fuel tanks at the fuel station from the selected fuel supplier.

The fuel price activation system performs one or more actions at each of the fuel stations via the network based on the selectively transmitted fuel prices. In an embodiment, one of the actions performed by the fuel price activation system comprises, for example, dynamically activating and displaying the selectively transmitted fuel prices on one or more display units positioned at each of the fuel stations, over the network. In another embodiment, one of the actions performed by the fuel price activation system comprises, for example, scheduling a refueling of fuel tanks at each of the fuel stations over the network based on the selectively transmitted fuel prices.

In an embodiment, the fuel price activation system at a fuel station computes a resultant fuel price for each of multiple fuel suppliers at multiple geographical locations based on the selectively transmitted fuel prices by adding the selectively transmitted fuel prices provided by each of the fuel suppliers and freight charges involved in transporting fuel to fuel tanks at the fuel station from the geographical locations of the fuel suppliers based on proximity of the geographical locations of the fuel suppliers to the fuel station. The fuel price activation system selects the lowest computed resultant fuel price and schedules delivery of the fuel to the fuel tanks at the fuel station from a selected fuel supplier associated with the selected lowest computed resultant fuel price.

In another embodiment, one of the actions performed by the fuel price activation system comprises, for example, transmitting one or more notifications on a low fuel price to the user devices via the network based on predetermined criteria. The predetermined criteria comprise, for example, frequency of visitation of users associated with the user devices to the fuel stations, proximity of the user devices to the fuel stations, etc. In another embodiment, one of the actions performed by the fuel price activation system comprises, for example, forecasting volume and grade such as regular, mid-grade, or premium grade of fuel required at each of the fuel stations at predetermined time intervals, for example, based on the selectively transmitted fuel prices, frequency of visitation of users associated with the user devices to each of the fuel stations, etc.

In another embodiment, one of the actions performed by the fuel price activation system comprises, for example, tracking a fuel level at each of multiple fuel tanks at each of the fuel stations via the network. The fuel price activation system is configured to communicate with each of the fuel tanks via the network. In this embodiment, the fuel price activation system transmits an alert message to one or more display units positioned at each of the fuel tanks via the network to indicate a low fuel level, when the fuel level is low at each of the fuel tanks. In another embodiment, one of the actions performed by the fuel price activation system comprises, for example, transmitting an alert message to one or more display units positioned at one or more of the fuel tanks at each of the fuel stations via the network to indicate shut down of each of the fuel stations due to gas spillage at the fuel tanks. In another embodiment, the fuel tanks at each of the fuel stations are configured to automatically charge users for fuel purchased based on the selectively transmitted fuel prices.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIGS. 1A-1B exemplarily illustrate a computer implemented method for managing actions associated with fuel prices at multiple fuel stations.

FIG. 1C exemplarily illustrates a computer implemented method for scheduling delivery of a low cost fuel to fuel tanks at a fuel station from a fuel supplier selected based on a lowest computed resultant fuel price.

FIGS. 2A-2B exemplarily illustrate a flowchart comprising the steps performed by a fuel price management server to manage actions associated with fuel prices at multiple fuel stations.

FIGS. 3A-3B exemplarily illustrate a flowchart comprising the steps performed by a fuel price activation system for performing multiple actions at each of the fuel stations based on fuel prices.

FIG. 4 exemplarily illustrates a computer implemented system for managing actions associated with fuel prices at a fuel station.

FIG. 5 exemplarily illustrates the architecture of a computer system employed by the fuel price management server and the fuel price activation system for managing actions associated with fuel prices at multiple fuel stations.

### DETAILED DESCRIPTION OF THE INVENTION

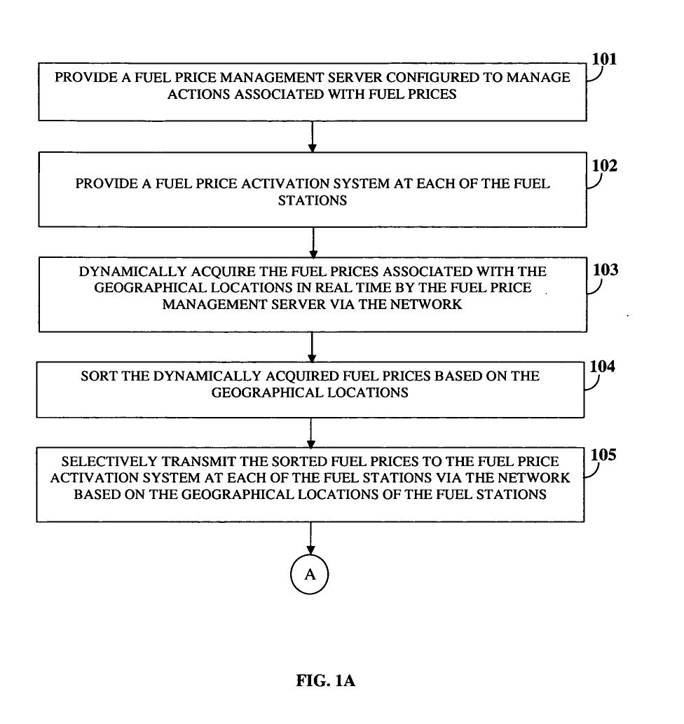

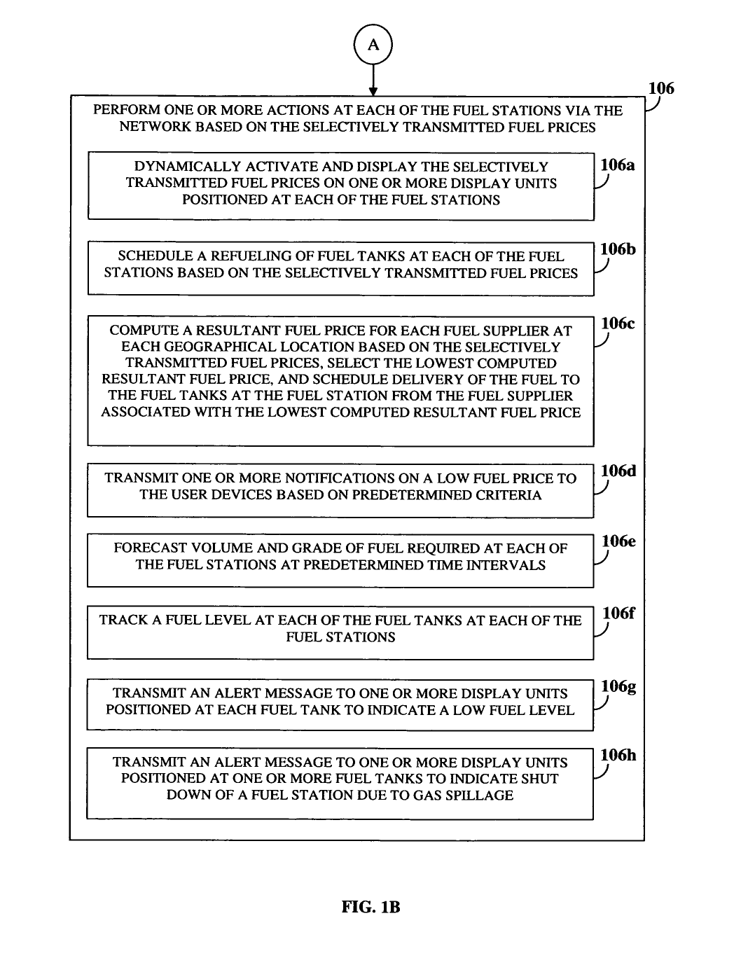

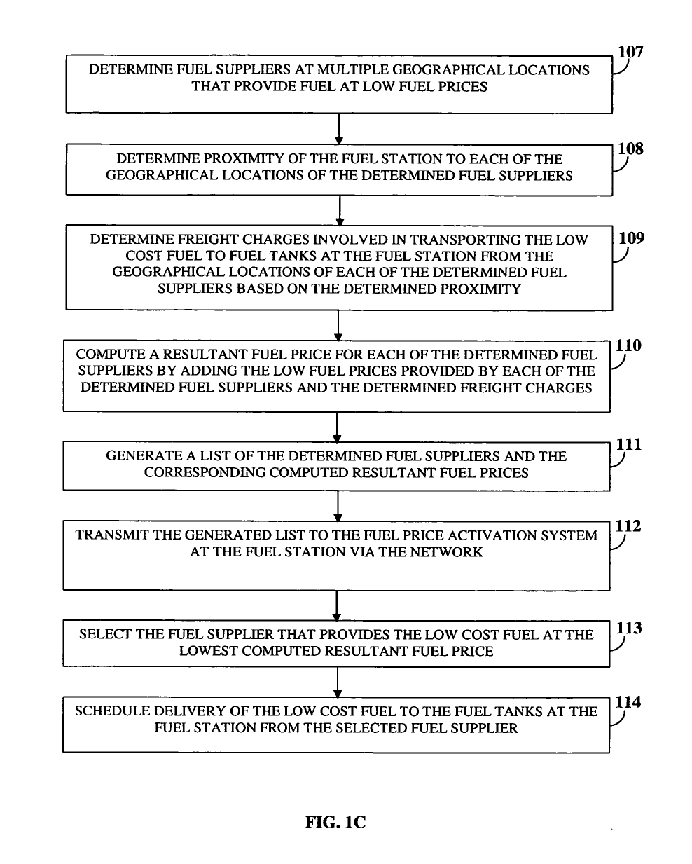

FIGS. 1A-1B exemplarily illustrate a computer implemented method for managing actions associated with fuel prices at multiple fuel stations. As used herein, the term “fuel station” refers to a facility, for example, a filling station, a gas station, a fueling station, a petrol pump, etc., that sells fuel, for example, gasoline including different grades of gasoline, kerosene, diesel oil, etc. The computer implemented method disclosed herein provides 101 a fuel price management server comprising at least one processor configured to manage the actions, for example, dynamically activating and displaying fuel prices on display units positioned at a fuel station, over the network, and other actions associated with the fuel prices. The fuel price management server is accessible by multiple user devices and fuel stations at multiple geographical locations via a network. The user devices comprise electronic devices, for example, personal computers, tablet computing devices, mobile computers, mobile phones, smart phones, portable computing devices, laptops, personal digital assistants, touch centric devices, portable electronic devices, network enabled computing devices, interactive network enabled communication devices, image capture devices, web browsers, any other suitable computing equipment, and combinations of multiple pieces of computing equipment, etc. The network is, for example, the internet, an intranet, a wireless network, a communication network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from a combination of these networks.

In an embodiment, the fuel price management server is implemented as an online server or a network of servers that hosts a website or a web based platform configured to provide access to fuel prices at multiple geographical locations in real time. As used herein, the term “geographical locations” refers to locations within a predefined area, for example, locations within the United States such as New York, San Francisco, Chicago, etc., and locations across the world, for example, locations such as New York, Paris, Sydney, etc. The computer implemented method disclosed herein also provides 102 a fuel price activation system at each of the fuel stations. The fuel price activation system is, for example, a computer system comprising at least one processor configured to communicate with the fuel price management server and one or more display units positioned at each of the fuel stations via the network, for example, the internet, a wide area network, a mobile communication network, etc. As used herein, the term “display unit” refers to an output device, for example, a monitor, a display board, a console, a graphical user interface, etc., that displays information, for example, fuel prices at fuel stations for viewing by users. The display units are positioned, for example, on each of multiple fuel tanks, on an active display board, etc., at each of the fuel stations.

The fuel price management server dynamically acquires 103 the fuel prices, for example, oil prices, gas prices, etc., associated with different geographical locations in real time via the network, for example, the internet, a mobile communication network, etc. The fuel price management server dynamically acquires the fuel prices, for example, from stock price systems, supply and demand systems, etc., that maintain stock prices for fuel, for example, for oil and gas with on the minute prices or government regulated prices that regulate how much a gallon of fuel would cost at each of the geographical locations via the network. The fuel price management server acquires the fuel prices from the geographical locations within an area and from the geographical locations across the world.

The fuel price management server sorts 104 the dynamically acquired fuel prices based on the geographical locations. The fuel price management server sorts the dynamically acquired fuel prices for geographical locations within an area and for geographical locations across the world. For example, the fuel price management server sorts the dynamically acquired fuel prices for different fuel stations in a particular location in New York, different cities in New York, different states in the United States of America, and different countries across the world. In an embodiment, the fuel price management server generates a list of selective sorted fuel prices based on a query request received from each of one or more user devices through a graphical user interface (GUI) provided by the fuel price management server via the network, for example, the interne, a mobile communication network, etc. For example, if a user enters a query requesting fuel prices at fuel stations within a particular geographical area via the GUI, the fuel price management server generates a list of fuel prices of all the fuel stations within the specified geographical area and renders the generated list to the user device via the GUI, thereby allowing the user to select a fuel station that offers the lowest fuel price. In another example, a user such as a motorist may access the GUI of the fuel price management server over a network such as the interne to obtain the location and price of a low cost fuel.

The fuel price management server selectively transmits 105 the sorted fuel prices to the fuel price activation system at each of the fuel stations via the network, for example, the internet, a wide area network, a mobile communication network, etc., based on the geographical locations of the fuel stations, for enabling the fuel price activation system to perform one or more of multiple actions associated with the fuel prices at each of the fuel stations based on the selectively transmitted fuel prices. For example, the fuel price management server transmits the updated fuel prices of a particular geographical location such as New York to the fuel price activation system at a fuel station located at a particular geographical location, for example, at 44-02 Astoria Blvd 5 and 44th Street in New York via the network in real time. Once the fuel prices are acquired from the geographical locations, the fuel price management server transmits the fuel prices via the network to every fuel station associated with the geographical region or location. For example, once the updated fuel prices are acquired from a geographical location such as New York, the fuel price management server transmits the updated fuel prices via the network to every fuel station in New York.

In an embodiment, the fuel price management server computes a target fuel price for a selected geographical location based on the dynamically acquired fuel prices associated with multiple geographical locations and transmits the target fuel price to the fuel price activation system at the selected geographical location via the network. As used herein, the term “target fuel price” refers to a suitable fuel price for a fuel station at a particular geographical location, computed or selected based on the dynamically acquired fuel prices associated with multiple geographical locations. To compute the target fuel price for a geographical location, the fuel price management server determines and tracks the real time accuracy of fuel prices dynamically acquired via the network or via multiple other communication networks from multiple geographical locations. For example, the fuel price management server dynamically acquires the fuel prices associated with multiple cities within a particular geographical location such as New York and computes the average of the fuel prices to obtain a target fuel price for a particular fuel station in a particular city or location within New York. In another example, the fuel price management server dynamically acquires the fuel prices associated with multiple cities within a particular geographical location such as New York and selects the least fuel price among the fuel prices of those cities as the target fuel price for a particular fuel station in a particular city or location within New York. In another embodiment, the fuel price activation system at a fuel station determines the target fuel price based on the selectively transmitted fuel prices received from the fuel price management server via the network. For example, the fuel price activation system at a fuel station in New York receives a list of fuel prices associated with multiple cities within New York from the fuel price management server via the network and selects and displays the least fuel price among the fuel prices of those cities as the target fuel price for the fuel station.

The fuel price activation system performs 106 one or more actions at each of the fuel stations via the network, based on the selectively transmitted fuel prices. In an embodiment, the fuel price activation system dynamically activates and displays 106a the selectively transmitted fuel prices on the display units positioned at each of the fuel stations, over the network. The fuel price activation system controls the display of the fuel prices on the display units. For example, the fuel price activation system, when authorized, automatically activates the fuel prices received from the fuel price management server via the network and displays the fuel prices on the display units such as a monitor positioned at the fuel tank, a fuel station display board, etc., to allow the users to view the changes in the fuel prices on the display units.

In another embodiment, one or more of the display units display information of an internet service, for example, a web link of a website hosted by the fuel price management server for accessing the fuel prices or for obtaining additional information on the fuel prices. For example, users may obtain information on the geographical location and the fuel price of a low cost fuel by accessing the website hosted by the fuel price management server. In another embodiment, the fuel price activation system schedules 106b a refueling of fuel tanks at each of the fuel stations over the network based on the selectively transmitted fuel prices. For example, the fuel price activation system schedules a refueling of the fuel tanks when the selectively transmitted fuel prices are lower than the previously transmitted fuel prices or when the fuel price of fuel to be filled in a particular fuel tank falls to a certain $ per gallon level.

In an embodiment, the fuel price activation system at a fuel station transmits a request for low fuel prices associated with multiple geographical locations to the fuel price management server via the network. On receiving a list of selectively transmitted fuel prices associated with fuel suppliers at the geographical locations requested by the fuel price activation system from the fuel price management server via the network, the fuel price activation system computes 106c a resultant fuel price for each fuel supplier at each geographical location based on the selectively transmitted fuel prices by adding the fuel price of the low cost fuel provided by the fuel supplier and the freight charge involved in transporting the low cost fuel to the fuel tanks at the fuel station from the fuel supplier's geographical location based on the proximity of the fuel supplier's geographical location to the fuel station. The fuel price activation system then selects the lowest computed resultant fuel price and schedules delivery of the fuel to the fuel tanks at the fuel station from the fuel supplier at the geographical location associated with the lowest computed resultant fuel price. The fuel price activation system at the fuel station therefore selects the fuel to be shipped from the fuel supplier to the fuel tanks at the fuel station based on the lowest fuel price and the freight charge from the fuel supplier to the fuel tanks to be fueled. The fuel supplier selected is the fuel supplier that provides the fuel at the lowest computed resultant fuel price. For example, if there are three fuel suppliers A, B, and C who provide low fuel prices at three different geographical locations at distances of 10 miles, 20 miles, and 30 miles respectively, from the fuel station, the fuel activation system computes the resultant fuel price for each of the three fuel suppliers by adding the fuel price provided by each fuel supplier and the corresponding freight charge involved in transporting the low cost fuel to the fuel tanks at the fuel station from each fuel supplier's geographical location based on the proximity of the fuel supplier's geographical location to the fuel station. In this example, since the fuel supplier A is in close proximity to the fuel station, the fuel price activation system computes the lowest resultant fuel price for fuel supplier A and therefore schedules delivery of the fuel to the fuel tanks at the fuel station from fuel supplier A.

In another embodiment, the fuel price activation system transmits 106d one or more notifications on a low fuel price to the user devices via the network based on predetermined criteria. The predetermined criteria comprise, for example, frequency of visitation of users associated with the user devices to the fuel stations, location of the user devices proximal to the fuel stations, etc. For example, if the fuel price activation system at a fuel station detects a user device that is registered with the fuel price activation system, in close proximity to the fuel station, when the fuel price is low, the fuel price activation system transmits a notification, for example, via electronic mail (email), a short message service (SMS), etc., to the user device to notify the user about the low fuel price. In another example, if a user registered with the fuel price activation system visits a fuel station frequently, the fuel price activation system transmits a notification to the user device via the network to alert the frequent user about the low fuel price. In another embodiment, the fuel price activation system forecasts 106e volume and grade such as regular, mid-grade, or premium grade of fuel required at each of the fuel stations at predetermined time intervals, for example, on a daily basis, a weekly basis, a monthly basis, etc., based on the selectively transmitted fuel prices, frequency of visitation of users associated with the user devices to each of the fuel stations, etc. For example, if the fuel price is low during a particular week, the fuel price activation system predicts that consumption of the fuel will be high during that week and determines the volume of fuel and type of fuel required at each of the fuel stations.

In another embodiment, the fuel price activation system tracks 106f a fuel level at each of multiple of fuel tanks at each of the fuel stations via the network. The fuel price activation system is configured to communicate with each of the fuel tanks via the network. In this embodiment, the fuel price activation system transmits 106g an alert message to one or more display units positioned at each of the fuel tanks via the network to indicate a low fuel level, for example, when the fuel level is low at each of the fuel tanks, before the fuel tanks are empty. On receiving the alert message from the fuel price activation system, the display unit positioned on a fuel tank with the low fuel level at the fuel station displays the alert message indicating a low fuel level. In another embodiment, the fuel price activation system transmits 106h an alert message to one or more display units positioned at one or more fuel tanks at each of the fuel stations via the network to indicate shut down of the fuel station due to gas spillage at the fuel tanks. For example, if there is a gas spillage at a fuel tank at a fuel station, the fuel price activation system transmits an alert message to a display unit positioned at each fuel tank or to an active display board of the fuel station via the network to indicate shut down of the fuel station. On receiving the alert message from the fuel price activation system, the display unit at each fuel tank or the active display board displays the alert message indicating the shutdown of the fuel station. In another embodiment, each fuel tank at each of the fuel stations is configured to automatically charge users for fuel purchased based on the selectively transmitted fuel prices.

In another embodiment, a television system that displays fuel prices communicates with the display units via the network to automatically change the fuel prices on the display units as they occur. The television system may be installed inside or outside each of the fuel stations.

FIG. 1C exemplarily illustrates a computer implemented method for scheduling delivery of a low cost fuel to fuel tanks at a fuel station from a fuel supplier selected based on a lowest computed resultant fuel price. In an embodiment, on receiving a request for low fuel prices from the fuel price activation system at a fuel station via the network, the fuel price management server determines 107 the fuel suppliers at multiple geographical locations that provide fuel at low fuel prices. The fuel price management server then determines 108 proximity of the fuel station to each of the geographical locations of the determined fuel suppliers. The fuel price management server then determines 109 the freight charges involved in transporting the low cost fuel to fuel tanks at the fuel station from the geographical locations of the determined fuel suppliers based on the determined proximity of the fuel station to each of the geographical locations of the determined fuel suppliers, and computes 110 a resultant fuel price for each of the determined fuel suppliers.

The fuel price management server computes 110 the resultant fuel price by adding the low fuel price provided by each determined fuel supplier and the corresponding determined freight charge. The fuel price management server generates 111 a list of the determined fuel suppliers and the corresponding computed resultant fuel prices. The fuel price management server then transmits 112 the generated list to the fuel price activation system at the fuel station via the network. On receiving the list from the fuel price management server, the fuel price activation system selects 113 the fuel supplier that provides fuel at the lowest computed resultant fuel price from the list and schedules 114 delivery of the fuel to the fuel tanks at the fuel station from the selected fuel supplier. In an embodiment, the fuel price management server selects the fuel supplier that provides fuel at the lowest computed resultant fuel price and transmits the contact information of the selected fuel supplier to the fuel price activation system via the network. The fuel price activation system may then contact the selected fuel supplier and schedule the delivery of the fuel to the fuel tanks at the fuel station from the selected fuel supplier.

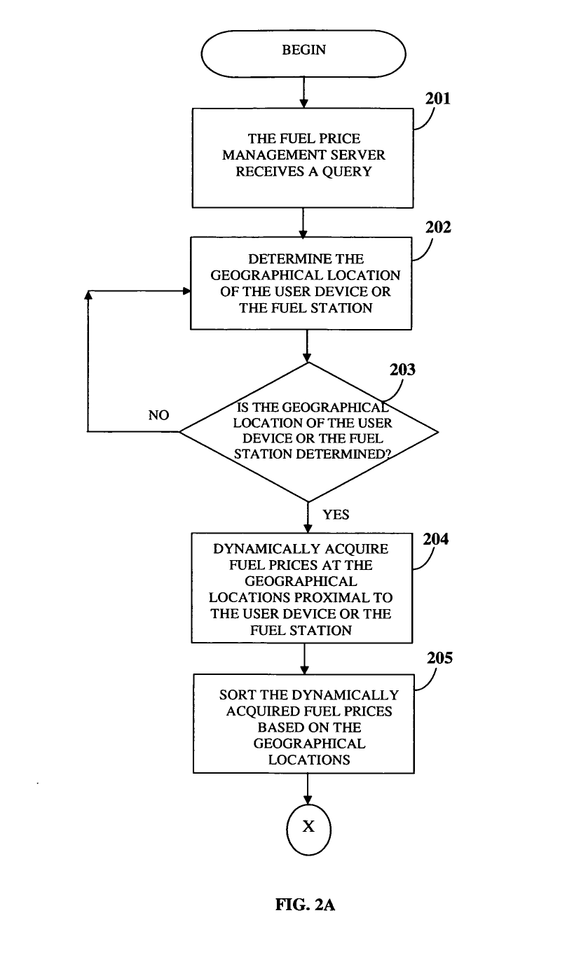

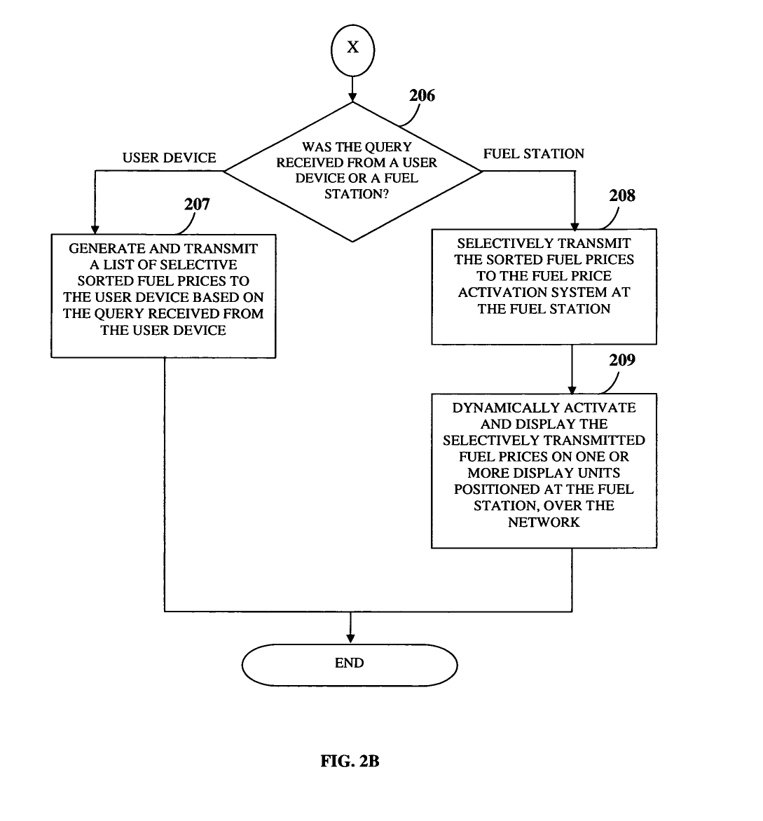

FIGS. 2A-2B exemplarily illustrate a flowchart comprising the steps performed by the fuel price management server to manage actions associated with fuel prices at multiple fuel stations. The fuel price management server receives 201 a query associated with fuel prices from a user device or a fuel station having the fuel price activation system. The fuel price management server determines 202 the geographical location of the user device or the fuel station, for example, using a network identifier such as an internet protocol (IP) address of the user device or the fuel price activation system. The fuel price management server can be configured to identify the geographical locations at every fuel station via the network, through any terminal in real time. Once the geographical location of the user device or the fuel station is determined 203, the fuel price management server dynamically acquires 204 fuel prices at all geographical locations proximal to the user device or the fuel station in real time. For example, if the geographical location of the user device or the fuel station is Sydney, the fuel price management server acquires the fuel prices at Sydney and at proximal geographical locations such as Canberra, Melbourne, etc. The fuel price management server sorts 205 the dynamically acquired fuel prices based on the geographical locations. For example, the fuel price management server sorts the dynamically acquired fuel prices based on the geographical locations such as Sydney, Canberra, Melbourne, etc.

The fuel price management server determines 206 whether the query was received from the user device or the fuel price activation system at a fuel station. If the query is received from the user device, the fuel price management server generates and transmits 207 a list of selective sorted fuel prices to the user device based on the query received from the user device through the graphical user interface (GUI) provided by the fuel price management server via the network, for example, the internet, a mobile communication network, etc. For example, if a user sent a query to the fuel price management server via the GUI requesting for fuel prices in Sydney, the fuel price management server transmits a list of fuel prices at fuel stations in Sydney to the user device via the network. If the query is received from the fuel price activation system of a fuel station, the fuel price management server selectively transmits 208 the sorted fuel prices to the fuel price activation system at the fuel station via the network, for example, the internet, a mobile communication network, etc., based on the geographical location of the fuel station. For example, if the geographical location of the fuel station is Sydney, the fuel price management server transmits the sorted fuel prices for the geographical location Sydney to the fuel price activation system at the fuel station in Sydney via the network, for example, the internet, a mobile communication network, etc. The fuel price activation system at the fuel station then dynamically activates and displays 209 the selectively transmitted fuel prices on one or more display units positioned at the fuel station in Sydney over the network, for example, a mobile communication network.

In an embodiment, the fuel price management server determines a target fuel price for the fuel station at Sydney based on the dynamically acquired fuel prices associated with the geographical locations such as Canberra, Melbourne, etc., and transmits the target fuel price to the fuel price activation system at the fuel station in Sydney via the network. In another embodiment, the fuel price management server transmits the list of fuel prices of the geographical locations such as Sydney, Canberra, and Melbourne to the fuel price activation system at the fuel station at Sydney via the network to allow the fuel price activation system to determine the target fuel price to display on the display unit at the fuel station in Sydney.

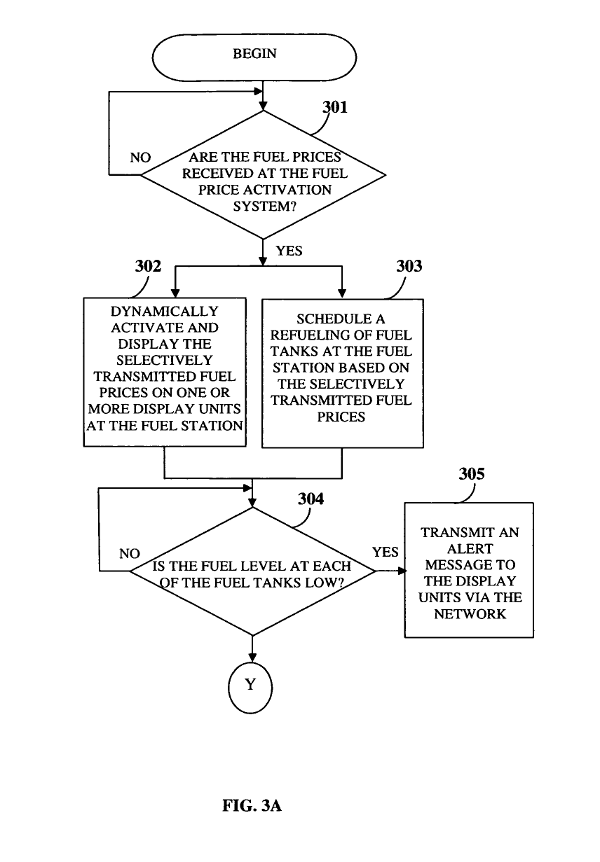

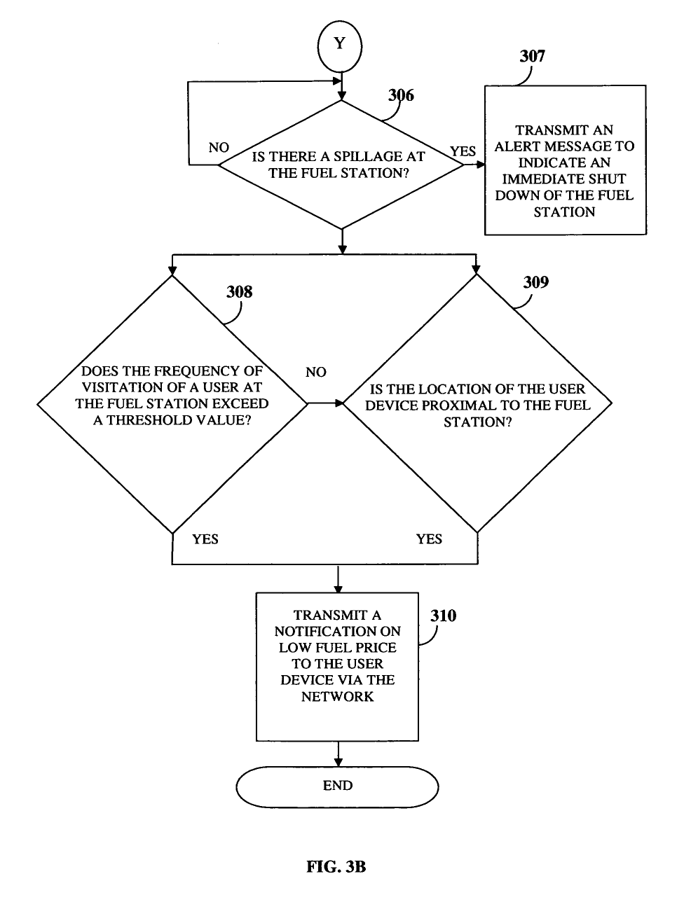

FIGS. 3A-3B exemplarily illustrate a flowchart comprising the steps performed by the fuel price activation system for performing multiple actions at each of the fuel stations based on fuel prices. As disclosed in the detailed description of FIGS. 1A-1B and FIGS. 2A-2B, the fuel price management server dynamically acquires and selectively transmits fuel prices to the fuel price activation system at each fuel station based on the geographical location of the fuel station. When the sorted fuel prices are received 301 by the fuel price activation system via the network, the fuel price activation system performs one or more actions at each of the fuel stations via the network based on the selectively transmitted fuel prices. In an example, the fuel price activation system dynamically activates and displays 302 the selectively transmitted fuel prices on one or more display units positioned at a fuel station over the network. In another example, the fuel price activation system schedules 303 a refueling of fuel tanks at the fuel station over the network based on the selectively transmitted fuel prices. That is, if the selectively transmitted fuel prices are low or reach a certain $/gallon level, the fuel price activation system immediately schedules a refueling of the fuel tanks. The fuel price activation system also tracks a fuel level at each of the fuel tanks at the fuel station. If the fuel level is low 304, the fuel price activation system transmits 305 an alert message to the display units positioned at the fuel tanks via the network to indicate a low fuel level. The fuel price activation system also checks 306 for gas spillage at the fuel station. If a gas spillage has occurred at the fuel station, the fuel price activation system transmits 307 an alert message to the display units at the fuel station to indicate an immediate shut down of the fuel station due to gas spillage. The fuel price activation system also transmits a notification on a low fuel price to a user device via the network based on predetermined criteria. If the frequency of visitation of a user associated with the user device to a fuel station exceeds a threshold value 308, the fuel price activation system transmits 310 the notification on the low fuel price to that user's user device via the network. If the location of the user device is proximal to the fuel station 309, the fuel price activation system transmits 310 the notification on the low fuel price to the user device via the network.

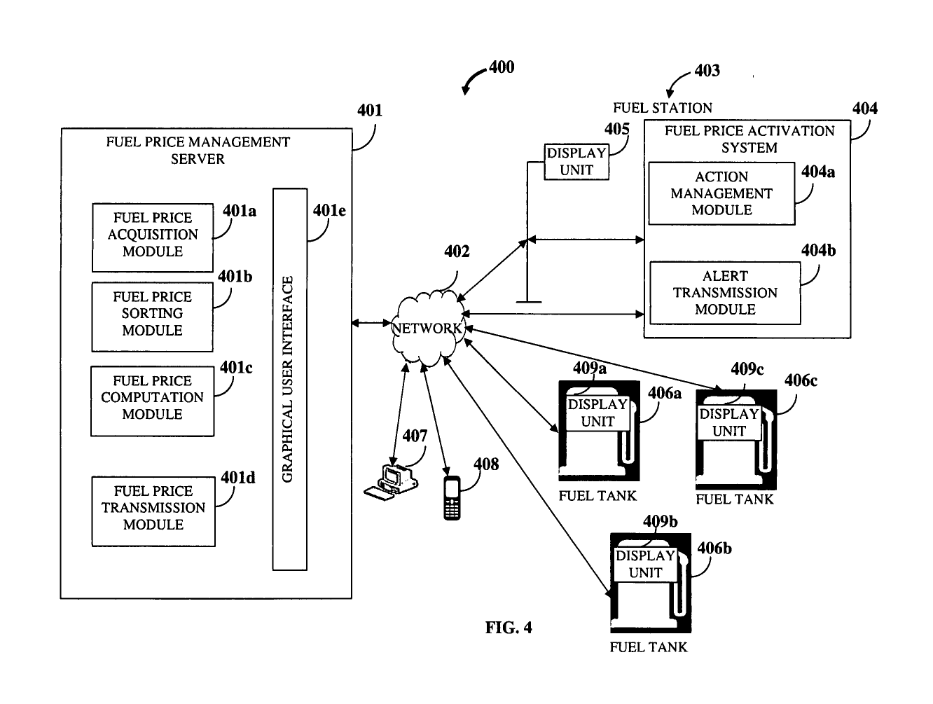

FIG. 4 exemplarily illustrates a computer implemented system 400 for managing actions associated with fuel prices at a fuel station 403. The computer implemented system 400 disclosed herein, also referred to as the “fuel price activation and management system” is configured to activate fuel prices at every fuel station 403 across the world. The fuel price activation and management system 400 comprises the fuel price management server 401 and the fuel price activation system 404. The fuel price management server 401 is accessible by multiple user devices, for example, a personal computer 407, a mobile phone 408, etc., and each fuel station 403 at each geographical location via a network 402. The network 402 is, for example, the internet, an intranet, a local area network, a wide area network, a communication network implementing Wi-Fi® of the Wireless Ethernet Compatibility Alliance, Inc., a cellular network, a mobile communication network, etc. The fuel price management server 401 comprises at least one processor configured to execute the modules 401a, 401b, 401c, and 401d of the fuel price management server 401. The fuel price management server 401 further comprises a non-transitory computer readable storage medium communicatively coupled to the processor. The non-transitory computer readable storage medium is configured to store the modules 401a, 401b, 401c, and 401d of the fuel price management server 401.

The fuel price management server 401 comprises a fuel price acquisition module 401a, a fuel price sorting module 401b, a fuel price computation module 401c, a fuel price transmission module 401d, and a graphical user interface (GUI) 401e. The fuel price acquisition module 401a dynamically acquires fuel prices associated with multiple geographical locations in real time via the network 402. The fuel price sorting module 401b sorts the dynamically acquired fuel prices based on the geographical locations. The fuel price transmission module 401d selectively transmits the sorted fuel prices to the fuel price activation system 404 at a fuel station 403 via the network 402 based on the geographical location of the fuel station 403. Similarly, the fuel price transmission module 401d selectively transmits the sorted fuel prices to the fuel price activation system 404 at every fuel station 403 associated with a geographical location via the network 402. In an embodiment, the fuel price sorting module 401b generates a list of selective sorted fuel prices, based on a query request received from each of the user devices 407, 408, etc., through the GUI 401e provided by the fuel price management server 401 via the network 402. The GUI 401e is, for example, a webpage of a website hosted by the fuel price management server 401, an online web interface, a web based downloadable application interface, a mobile based downloadable application interface, etc.

The fuel price computation module 401c computes a target fuel price for a selected geographical location based on the dynamically acquired fuel prices associated with multiple geographical locations. The fuel price transmission module 401d transmits the target fuel price to the fuel price activation system 404 at the selected geographical location via the network 402. In an embodiment, the fuel price computation module 401c determines fuel suppliers at multiple geographical locations that provide fuel at low fuel prices. The fuel price computation module 401c determines proximity of each fuel station 403 to each of the geographical locations of the determined fuel suppliers. The fuel price computation module 401c determines freight charges involved in transporting a low cost fuel to fuel tanks, for example, 406a, 406b, and 406c at each fuel station 403 from the geographical locations of the determined fuel suppliers based on the determined proximity of each fuel station 403 to each geographical location of the determined fuel suppliers. The fuel price computation module 401c computes a resultant fuel price for each of the determined fuel suppliers by adding the low fuel prices provided by each of the determined fuel suppliers and the determined freight charges. The fuel price computation module 401c generates and transmits a list of the determined fuel suppliers and the computed resultant fuel price associated with each of the determined fuel suppliers to the fuel price activation system 404 at each fuel station 403 via the network 402. The fuel price activation system 404 selects the fuel supplier that provides the low cost fuel at the lowest computed resultant fuel price from the list and schedules delivery of the low cost fuel to the fuel tanks 406a, 406b, and 406c at the fuel station 403 from the selected fuel supplier.

The fuel price activation system 404 at the fuel station 403 communicates with the fuel price management server 401 and one or more display units, for example, 405, 409a, 409b, 409c, etc., positioned at the fuel station 403 via the network 402. The fuel price activation system 404 comprises at least one processor configured to execute the modules 404a and 404b of the fuel price activation system 404. The fuel price activation system 404 further comprises a non-transitory computer readable storage medium communicatively coupled to the processor. The non-transitory computer readable storage medium is configured to store the modules 404a and 404b of the fuel price activation system 404. The fuel price activation system 404 communicates with each of the fuel tanks 406a, 406b, and 406c at the fuel station 403 via the network 402. The fuel price activation system 404 comprises an action management module 404a and an alert transmission module 404b. The action management module 404a performs one or more actions at the fuel station 403 via the network 402 based on the selectively transmitted fuel prices. For example, the action management module 404a dynamically activates and transmits the fuel prices to one or more display units, for example, 409a, 409b, 409c, etc., positioned at the fuel tanks 406a, 406b, 406c, etc., respectively at the fuel station 403 and to the active display unit 405, over the network 402, for example, the internet, a mobile communication network, etc. The display units, for example, 405, 409a, 409b, 409c, etc., positioned at the fuel station 403 display the fuel prices. The display units, for example, 409a, 409b, and 409c at the fuel tanks 406a, 406b, and 406c respectively, and the active display unit 405 display the changed fuel prices automatically. Users can view the fuel price changes as they occur on the display units 405, 409a, 409b, and 409c. In another example, the action management module 404a schedules a refueling of each of the fuel tanks 406a, 406b, and 406c at the fuel station 403 over the network 402 based on the selectively transmitted fuel prices.

In an embodiment, the action management module 404a computes a resultant fuel price for each of multiple fuel suppliers at multiple geographical locations based on the selectively transmitted fuel prices by adding the selectively transmitted fuel prices provided by each of the fuel suppliers and freight charges involved in transporting fuel to fuel tanks 406a, 406b, and 406c at the fuel station 403 from the geographical locations of the fuel suppliers based on the proximity of the geographical locations of the fuel suppliers to the fuel station 403. The action management module 404a selects the lowest computed resultant fuel price and schedules delivery of the fuel to the fuel tanks 406a, 406b, and 406c at the fuel station 403 from a selected fuel supplier associated with the selected lowest computed resultant fuel price.

The alert transmission module 404b transmits one or more notifications on a low fuel price to the user devices 407, 408, etc., via the network 402 based on predetermined criteria comprising, for example, frequency of visitation of users associated with the user devices 407, 408, etc., to the fuel stations 403, proximity of the user devices 407, 408, etc., to the fuel stations 403, etc. The alert transmission module 404b also transmits an alert message to the display units 409a, 409b, and 409c positioned at the fuel tanks 406a, 406b, and 406c respectively, at the fuel station 403 via the network 402 to indicate shut down of the fuel station 403 due to gas spillage at the fuel tanks 406a, 406b, and 406c. The action management module 404a also tracks a fuel level at each of the fuel tanks 406a, 406b, and 406c at the fuel station 403 via the network 402. The alert transmission module 404b transmits an alert message to the display units 409a, 409b, and 409c positioned at the fuel tanks 406a, 406b, and 406c respectively, via the network 402 to indicate a low fuel level, when the fuel level is low at the fuel tanks 406a, 406b, and 406c. In an embodiment, the action management module 404a also forecasts volume and grade such as regular, mid-grade, or premium grade of fuel required at the fuel station 403 at predetermined time intervals, for example, based on the selectively transmitted fuel prices and frequency of visitation of users associated with the user devices 407, 408, etc., to the fuel station 403. In another embodiment, the action management module 404a, in communication with each of the fuel tanks 406a, 406b, and 406c at the fuel station 403 via the network 402, is configured to automatically charge users for fuel purchased based on the selectively transmitted fuel prices.

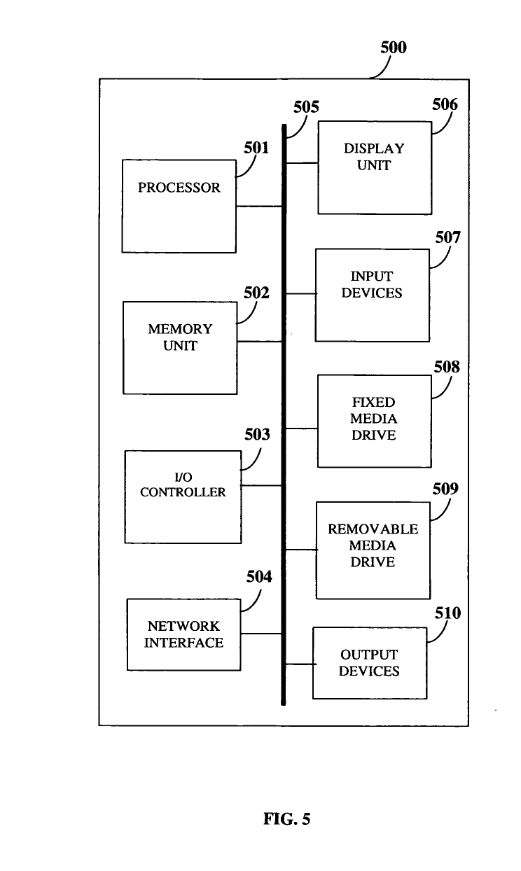

FIG. 5 exemplarily illustrates the architecture of a computer system 500 employed by the fuel price management server 401 and the fuel price activation system 404 exemplarily illustrated in FIG. 4, for managing actions associated with fuel prices at multiple fuel stations 403. The fuel price management server 401 and the fuel price activation system 404 of the fuel price activation and management system 400 disclosed herein employ the architecture of the computer system 500 exemplarily illustrated in FIG. 5. The computer system 500 is programmable using a high level computer programming language. The computer system 500 may be implemented using programmed and purposeful hardware.

The fuel price management server 401 and the fuel price activation system 404 communicate with the user devices 407, 408, etc., via the network 402, for example, a short range network or a long range network. The computer system 500 comprises, for example, a processor 501, a memory unit 502 for storing programs and data, an input/output (I/O) controller 503, a network interface 504, a data bus 505, a display unit 506, input devices 507, a fixed media drive 508, a removable media drive 509 for receiving removable media, output devices 510, etc.

The term “processor” refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 501 may also be implemented as a processor set comprising, for example, a general purpose microprocessor and a math or graphics co-processor. The processor 501 is selected, for example, from the Intel® processors such as the Itanium® microprocessor or the Pentium® processors, Advanced Micro Devices (AMD®) processors such as the Athlon® processor, UltraSPARC® processors, microSPARC™ processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, etc. The fuel price management server 401 and the fuel price activation system 404 are each not limited to a computer system 500 employing a processor 501. The computer system 500 may also employ a controller or a microcontroller.

The memory unit 502 is used for storing programs, applications, and data. For example, the fuel price acquisition module 401a, the fuel price sorting module 401b, the fuel price computation module 401c, and the fuel price transmission module 401d of the fuel price management server 401 are stored in the memory unit 502 of the fuel price management server 401. The action management module 404a and the alert transmission module 404b of the fuel price activation system 404 are stored in the memory unit 502 of the fuel price activation system 404. The memory unit 502 is, for example, a random access memory (RAM) or another type of dynamic storage device that stores information and instructions for execution by the processor 501. The memory unit 502 also stores temporary variables and other intermediate information used during execution of instructions by the processor 501. The computer system 500 further comprises a read only memory (ROM) or another type of static storage device that stores static information and instructions for the processor 501.

The network interface 504 enables connection of the computer system 500 to the network 402. For example, the fuel price management server 401 and the fuel price activation system 404 connect to the network 402 via their respective network interfaces 504. In an embodiment, the network interface 504 is provided as an interface card also referred to as a line card. The network interface 504 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high-speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The I/O controller 503 controls input actions and output actions performed by the fuel price management server 401 and the fuel price activation system 404. The data bus 505 permits communication between the modules, for example, 401a, 401b, 401c, and 401d of the fuel price management server 401, and the modules, for example, 404a and 404b of the fuel price activation system 404.

The display unit 506 of the fuel price activation system 404, via the graphical user interface (GUI) 401e, displays information, display interfaces, user interface elements such as text fields, checkboxes, text boxes, windows, etc., for displaying selectively transmitted fuel prices, etc. The display unit 506 comprises, for example, a liquid crystal display, a plasma display, an organic light emitting diode (OLED) based display, etc. The input devices 507 are used for inputting data into the computer system 500. For example, a user enters a query request for generating a list of selective sorted fuel prices using the input devices 507. The input devices 507 are, for example, a keyboard such as an alphanumeric keyboard, a joystick, a pointing device such as a computer mouse, a touch pad, a light pen, a physical button, a pointing device, a touch sensitive display device, a track ball, a pointing stick, any device capable of sensing a tactile input, etc.

Computer applications and programs are used for operating the computer system 500. The programs are loaded onto the fixed media drive 508 and into the memory unit 502 of the computer system 500 via the removable media drive 509. In an embodiment, the computer applications and programs may be loaded directly via the network 402. Computer applications and programs are executed by double clicking a related icon displayed on the display unit 506 using one of the input devices 507. The output devices 510 output the results of operations performed by the fuel price management server 401 and the fuel price activation system 404. In an example, the fuel price activation system 404 at each fuel station 403 displays the selectively transmitted fuel prices using the output devices 510.

The processor 501 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, Windows Phone™ operating system of Microsoft Corporation, BlackBerry® operating system of Research in Motion Limited, the iOS operating system of Apple Inc., the Symbian® operating system of Symbian Foundation Limited, etc. The computer system 500 employs the operating system for performing multiple tasks. The operating system is responsible for management and coordination of activities and sharing of resources of the computer system 500. The operating system further manages security of the computer system 500, peripheral devices connected to the computer system 500, and network connections. The operating system employed on the computer system 500 recognizes, for example, inputs provided by users using one of the input devices 507, the output display, files, and directories stored locally on the fixed media drive 508, for example, a hard drive. The operating system on the computer system 500 executes different programs using the processor 501. The processor 501 and the operating system together define a computer platform for which application programs in high level programming languages are written. The fuel price management server 401 and the fuel price activation system 404 can be utilized or configured with any processor 501 or using software to take command and be executed in any programming language.

The processor 501 retrieves instructions for executing the modules, for example, 401a, 401b, 401c, and 401d of the fuel price management server 401 and the modules, for example, 404a and 404b of the fuel price activation system 404 from their respective memory units 502. A program counter determines the location of the instructions in the memory unit 502. The program counter stores a number that identifies a current position in a program of each of the modules, for example, 401a, 401b, 401c, and 401d of the fuel price management server 401 and the modules, for example, 404a and 404b of the fuel price activation system 404. The instructions fetched by the processor 501 from the memory unit 502 after being processed are decoded. The instructions are stored in an instruction register in the processor 501. After processing and decoding, the processor 501 executes the instructions. For example, the fuel price acquisition module 401a defines instructions for dynamically acquiring the fuel prices associated with the geographical locations in real time via the network 402. The fuel price sorting module 401b defines instructions for sorting the dynamically acquired fuel prices based on the geographical locations. The fuel price transmission module 401d defines instructions for selectively transmitting the sorted fuel prices to the fuel price activation system 404 at each of the fuel stations 403 via the network 402 based on the geographical locations of the fuel stations 403. The fuel price sorting module 401b defines instructions for generating a list of the selective sorted fuel prices based on a query request received from each of one or more user devices 407, 408, etc., through the GUI 401e provided by the fuel price management server 401 via the network 402. The fuel price computation module 401c defines instructions for computing a target fuel price for a selected geographical location based on the dynamically acquired fuel prices associated with multiple geographical locations. The fuel price transmission module 401d defines instructions for transmitting the target fuel price to the fuel price activation system 404 at the selected geographical location via the network 402.

In an embodiment, the fuel price computation module 401c defines instructions for determining fuel suppliers at multiple geographical locations that provide fuel at low fuel prices. The fuel price computation module 401c also defines instructions for determining proximity of each fuel station 403 to each of the geographical locations of the determined fuel suppliers. The fuel price computation module 401c also defines instructions for determining freight charges involved in transporting a low cost fuel to fuel tanks, for example, 406a, 406b, and 406c at each fuel station 403 from the geographical locations of the determined fuel suppliers based on the determined proximity of each fuel station 403 to each geographical location of the determined fuel suppliers. The fuel price computation module 401c also defines instructions for computing a resultant fuel price for each of the determined fuel suppliers by adding the low fuel prices provided by each of the determined fuel suppliers and the determined freight charges. The fuel price computation module 401c also defines instructions for generating and transmitting a list of the determined fuel suppliers and the computed resultant fuel price associated with each of the determined fuel suppliers to the fuel price activation system 404 at each fuel station 403 via the network 402.

The action management module 404a defines instructions for performing one or more actions at each of the fuel stations 403 via the network 402, based on the selectively transmitted fuel prices. For example, the action management module 404a defines instructions for dynamically activating and transmitting the fuel prices to one or more display units, for example, 409a, 409b, 409c, etc., positioned at the fuel tanks 406a, 406b, 406c, etc., respectively at the fuel station 403 and to the active display unit 405, over the network 402, for example, the internet, a mobile communication network, etc. The action management module 404a also defines instructions for scheduling a refueling of each of the fuel tanks 406a, 406b, and 406c at the fuel station 403 over the network 402 based on the selectively transmitted fuel prices.

In an embodiment, the action management module 404a defines instructions for computing a resultant fuel price for each of multiple fuel suppliers at multiple geographical locations based on the selectively transmitted fuel prices by adding the selectively transmitted fuel prices provided by each of the fuel suppliers and freight charges involved in transporting fuel to fuel tanks 406a, 406b, and 406c at the fuel station 403 from the geographical locations of the fuel suppliers based on the proximity of the geographical locations of the fuel suppliers to the fuel station 403. The action management module 404a also defines instructions for selecting the fuel supplier that provides the low cost fuel at the lowest computed resultant fuel price and scheduling delivery of the low cost fuel to the fuel tanks 406a, 406b, and 406c at the fuel station 403 from the selected fuel supplier.

Furthermore, the alert transmission module 404b defines instructions for transmitting one or more notifications on a low fuel price to the user devices 407, 408, etc., via the network 402 based on predetermined criteria. Furthermore, the alert transmission module 404b defines instructions for transmitting an alert message to the display units 409a, 409b, and 409c positioned at the fuel tanks 406a, 406b, and 406c respectively, at the fuel station 403 via the network 402 to indicate shut down of the fuel station 403 due to gas spillage at the fuel tanks 406a, 406b, and 406c.

The action management module 404a also defines instructions for tracking a fuel level at each of the fuel tanks 406a, 406b, and 406c at the fuel station 403 via the network 402. The alert transmission module 404b defines instructions for transmitting an alert message to the display units 409a, 409b, and 409c positioned at the fuel tanks 406a, 406b, and 406c respectively, to indicate a low fuel level, when the fuel level is low at each of the fuel tanks 406a, 406b, and 406c. In an embodiment, the action management module 404a also defines instructions for forecasting volume and grade such as regular, mid-grade, or premium grade of fuel required at the fuel station 403 at predetermined time intervals, for example, based on the selectively transmitted fuel prices, frequency of visitation of users associated with the user devices 407, 408, etc., to the fuel station 403.

The processor 501 of the computer system 500 employed by the fuel price management server 401 retrieves the instructions defined by the fuel price acquisition module 401a, the fuel price sorting module 401b, the fuel price computation module 401c, and the fuel price transmission module 401d, and executes the instructions, thereby performing one or more processes defined by those instructions. The processor 501 of the computer system 500 employed by the fuel price activation system 404 retrieves the instructions defined by the action management module 404a and the alert transmission module 404b of the fuel price activation system 404 and executes the instructions, thereby performing one or more processes defined by those instructions.

At the time of execution, the instructions stored in the instruction register are examined to determine the operations to be performed. The processor 501 then performs the specified operations. The operations comprise arithmetic operations and logic operations. The operating system performs multiple routines for performing a number of tasks required to assign the input devices 507, the output devices 510, and memory for execution of the modules, for example, 401a, 401b, 401c, 401d, etc., of the fuel price management server 401, and the modules, for example, 404a and 404b of the fuel price activation system 404. The tasks performed by the operating system comprise, for example, assigning memory to the modules, for example, 401a, 401b, 401c, and 401d of the fuel price management server 401, and the modules, for example, 404a and 404b of the fuel price activation system 404, and to data used by the fuel price management server 401 and the fuel price activation system 404, moving data between the memory unit 502 and disk units, and handling input/output operations. The operating system performs the tasks on request by the operations and after performing the tasks, the operating system transfers the execution control back to the processor 501. The processor 501 continues the execution to obtain one or more outputs. The outputs of the execution of the modules, for example, 401a, 401b, 401c, 401d, etc., of the fuel price management server 401, and the modules, for example, 404a and 404b of the fuel price activation system 404 are displayed to the user on the display unit 506.

For purposes of illustration, the detailed description refers to the fuel price management server 401 and the fuel price activation system 404 disclosed herein each being run locally on the computer system 500; however the scope of the computer implemented method and system 400 disclosed herein is not limited to the fuel price management server 401 and the fuel price activation system 404 being run locally on the computer system 500 via the operating system and the processor 501 but may be extended to run remotely over the network 402, for example, by employing a web browser and a remote server, a mobile phone, or other electronic devices. One or more portions of the computer system 500 may be distributed across one or more computer systems (not shown) coupled to the network 402.

Disclosed herein is also a computer program product comprising a non-transitory computer readable storage medium that stores computer program codes comprising instructions executable by at least one processor 501 for managing actions associated with fuel prices at multiple fuel stations 403. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 501, except for a transitory, propagating signal.

The computer program codes comprise a first computer program code for dynamically acquiring fuel prices associated with geographical locations in real time via the network 402; a second computer program code for sorting the dynamically acquired fuel prices based on the geographical locations; and a third computer program code for selectively transmitting the sorted fuel prices to the fuel price activation system 404 at each fuel station 403 via the network 402 based on the geographical location of each fuel station 403 for enabling the fuel price activation system 404 to perform one or more actions at each fuel station 403 via the network 402, based on the selectively transmitted fuel prices.

The computer program product disclosed herein further comprises a fourth computer program code for determining fuel suppliers at multiple geographical locations that provide fuel at low fuel prices; a fifth computer program code for determining proximity of each fuel station 403 to each of the geographical locations of the determined fuel suppliers; a sixth computer program code for determining freight charges involved in transporting a low cost fuel to fuel tanks 406a, 406b, and 406c at each fuel station 403 from the geographical locations of the determined fuel suppliers based on the determined proximity of each fuel station 403 to each geographical location of the determined fuel suppliers; a seventh computer program code for computing a resultant fuel price for each of the determined fuel suppliers by adding the low fuel prices provided by each of the determined fuel suppliers and the determined freight charges; and an eighth computer program code for generating and transmitting a list of the determined fuel suppliers and the corresponding computed resultant fuel prices to the fuel price activation system 404 at each fuel station 403 via the network 402 for selection by the fuel price activation system 404.

The computer program product disclosed herein further comprises one or more additional computer program codes for performing additional steps that may be required and contemplated for managing actions associated with fuel prices at multiple fuel stations. In an embodiment, a single piece of computer program code comprising computer executable instructions performs one or more steps of the computer implemented method disclosed herein for managing actions associated with fuel prices at multiple fuel stations. The computer program codes comprising the computer executable instructions are embodied on the non-transitory computer readable storage medium. The processor 501 of the computer system 500 retrieves these computer executable instructions and executes them. When the computer executable instructions are executed by the processor 501, the computer executable instructions cause the processor 501 to perform the steps of the computer implemented method for managing actions associated with fuel prices at multiple fuel stations.

It will be readily apparent that the various methods, algorithms, and computer programs disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, Fortran, Ruby, Pascal, Perl®, Python®, Visual Basic®, MATLAB®, etc. Other object-oriented, functional, scripting, and/or logical programming languages may also be used. The computer program codes or software programs may be stored on or in one or more mediums as object code. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices may comprise processors, for example, the Intel® processors, Advanced Micro Devices (AMD®) processors, UltraSPARC® processors, Hp® processors, International Business Machines (IBM®) processors, RISC based computer processors of ARM Holdings, Motorola® processors, etc., that are adapted to communicate with the computers. In an embodiment, each of the computers is equipped with a network communication device, for example, a network interface card, a modem, or other network connection device suitable for connecting to a network. Each of the computers and the devices executes an operating system, for example, the Linux® operating system, the Unix® operating system, any version of the Microsoft® Windows® operating system, the Mac OS of Apple Inc., the IBM® OS/2, the Palm OS®, the Solaris operating system developed by Sun Microsystems, Inc., or any other operating system. Handheld devices execute operating systems, for example, the Android operating system, the Windows Phone™ operating system of Microsoft Corporation, the BlackBerry® operating system of Research in Motion Limited, the iOS operating system of Apple Inc., the Symbian® operating system of Symbian Foundation Limited, etc. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for managing actions associated with fuel prices at a plurality of fuel stations, comprising:
providing a fuel price management server comprising at least one processor configured to manage said actions associated with said fuel prices, wherein said fuel price management server is accessible by a plurality of user devices and said fuel stations at a plurality of geographical locations via a network;
providing a fuel price activation system at each of said fuel stations, wherein said fuel price activation system comprises at least one processor configured to communicate with said fuel price management server and one or more display units positioned at said each of said fuel stations via said network;
dynamically acquiring said fuel prices associated with said geographical locations in real time by said fuel price management server via said network;
sorting said dynamically acquired fuel prices based on said geographical locations by said fuel price management server; and
selectively transmitting said sorted fuel prices to said fuel price activation system at said each of said fuel stations by said fuel price management server via said network based on said geographical locations of said fuel stations, for enabling said fuel price activation system to perform one or more of said actions at said each of said fuel stations via said network based on said selectively transmitted fuel prices.

2. The computer implemented method of claim 1, further comprising generating a list of selective said sorted fuel prices by said fuel price management server, based on a query request received from each of one or more of said user devices through a graphical user interface provided by said fuel price management server via said network.

3. The computer implemented method of claim 1, further comprising computing a target fuel price for a selected one of said geographical locations by said fuel price management server based on said dynamically acquired fuel prices associated with said geographical locations and transmitting said target fuel price by said fuel price management server to said fuel price activation system at said selected one of said geographical locations via said network.

4. The computer implemented method of claim 1, further comprising:
determining fuel suppliers at a plurality of geographical locations that provide fuel at low fuel prices by said fuel price management server;
determining proximity of said each of said fuel stations to each of said geographical locations of said determined fuel suppliers by said fuel price management server;
determining freight charges involved in transporting a low cost fuel to fuel tanks at said each of said fuel stations from said geographical locations of said determined fuel suppliers by said fuel price management server based on said determined proximity of said each of said fuel stations to said each of said geographical locations of said determined fuel suppliers;
computing a resultant fuel price for each of said determined fuel suppliers by said fuel price management server by adding said low fuel prices provided by each of said determined fuel suppliers and said determined freight charges; and
generating and transmitting a list of said determined fuel suppliers and said computed resultant fuel price associated with each of said determined fuel suppliers to said fuel price activation system at said each of said fuel stations by said fuel price management server via said network.

5. The computer implemented method of claim 4, further comprising selecting one of said determined fuel suppliers that provides said low cost fuel at a lowest said computed resultant fuel price from said list by said fuel price activation system at said each of said fuel stations and scheduling delivery of said low cost fuel to said fuel tanks at said each of said fuel stations from said selected one of said determined fuel suppliers by said fuel price activation system.

6. The computer implemented method of claim 1, wherein said actions comprise:
dynamically activating and displaying said selectively transmitted fuel prices on said one or more display units positioned at said each of said fuel stations, over said network; and
scheduling a refueling of fuel tanks at said each of said fuel stations by said fuel price activation system over said network based on said selectively transmitted fuel prices.

7. The computer implemented method of claim 1, further comprising:
computing a resultant fuel price for each of a plurality of fuel suppliers at a plurality of geographical locations by said fuel price activation system based on said selectively transmitted fuel prices by adding said selectively transmitted fuel prices provided by each of said fuel suppliers and freight charges involved in transporting fuel to fuel tanks at said each of said fuel stations from said geographical locations of said fuel suppliers based on proximity of said geographical locations of said fuel suppliers to said each of said fuel stations;
selecting a lowest said computed resultant fuel price by said fuel price activation system; and
scheduling delivery of said fuel to said fuel tanks at said each of said fuel stations from a selected one of said fuel suppliers associated with said selected lowest computed resultant fuel price by said fuel price activation system.

8. The computer implemented method of claim 1, wherein said actions comprise:
transmitting one or more notifications on a low fuel price to said user devices by said fuel price activation system via said network based on predetermined criteria, wherein said predetermined criteria comprise frequency of visitation of users associated with said user devices to said fuel stations, and proximity of said user devices to said fuel stations; and
transmitting an alert message to said one or more display units positioned at one or more of a plurality of fuel tanks at said each of said fuel stations by said fuel price activation system via said network to indicate shut down of said each of said fuel stations due to gas spillage at said one or more of said fuel tanks.

9. The computer implemented method of claim 1, wherein one of said actions comprises forecasting volume and grade of fuel required at said each of said fuel stations by said fuel price activation system at predetermined time intervals based on said selectively transmitted fuel prices and frequency of visitation of users associated with said user devices to said each of said fuel stations.

10. The computer implemented method of claim 1, wherein one of said actions comprises tracking a fuel level at each of a plurality of fuel tanks at said each of said fuel stations by said fuel price activation system via said network, wherein said fuel price activation system is configured to communicate with said each of said fuel tanks via said network, and wherein said fuel price activation system is further configured to transmit an alert message to said one or more display units positioned at said each of said fuel tanks via said network to indicate a low said fuel level, when said fuel level is low at said each of said fuel tanks.

11. The computer implemented method of claim 1, further comprising configuring each of a plurality of fuel tanks at said each of said fuel stations to automatically charge users for fuel purchased based on said selectively transmitted fuel prices.

12. A computer implemented system for managing actions associated with fuel prices at a plurality of fuel stations, comprising:
a fuel price management server accessible by a plurality of user devices and said fuel stations at a plurality of geographical locations via a network, said fuel price management server comprising:
at least one processor;
a first non-transitory computer readable storage medium communicatively coupled to said at least one processor, said first non-transitory computer readable storage medium configured to store modules of said fuel price management server, said at least one processor configured to execute said modules of said fuel price management server; and
said modules of said fuel price management server comprising:
a fuel price acquisition module configured to dynamically acquire said fuel prices associated with said geographical locations in real time via said network;
a fuel price sorting module configured to sort said dynamically acquired fuel prices based on said geographical locations; and
a fuel price transmission module configured to selectively transmit said sorted fuel prices to a fuel price activation system at each of said fuel stations via said network based on said geographical locations of said fuel stations; and
said fuel price activation system at said each of said fuel stations, said fuel price activation system configured to communicate with said fuel price management server and one or more display units positioned at said each of said fuel stations via said network, said fuel price activation system comprising:
at least one processor;
a second non-transitory computer readable storage medium communicatively coupled to said at least one processor, said second non-transitory computer readable storage medium configured to store modules of said fuel price activation system, said at least one processor configured to execute said modules of said fuel price activation system; and
said modules of said fuel price activation system comprising an action management module configured to perform one or more of said actions at said each of said fuel stations via said network based on said selectively transmitted fuel prices.

13. The computer implemented system of claim 12, wherein said fuel price sorting module of said fuel price management server is further configured to generate a list of selective said sorted fuel prices based on a query request received from each of one or more of said user devices through a graphical user interface provided by said fuel price management server via said network.

14. The computer implemented system of claim 12, wherein said modules of said fuel price management server further comprise a fuel price computation module configured to compute a target fuel price for a selected one of said geographical locations based on said dynamically acquired fuel prices associated with said geographical locations, and wherein said fuel price transmission module is further configured to transmit said target fuel price to said fuel price activation system at said selected one of said geographical locations via said network.

15. The computer implemented system of claim 14, wherein said fuel price computation module is further configured to perform:
determining fuel suppliers at a plurality of geographical locations that provide fuel at low fuel prices;
determining proximity of said each of said fuel stations to each of said geographical locations of said determined fuel suppliers;
determining freight charges involved in transporting a low cost fuel to fuel tanks at said each of said fuel stations from said geographical locations of said determined fuel suppliers based on said determined proximity of said each of said fuel stations to said each of said geographical locations of said determined fuel suppliers;
computing a resultant fuel price for each of said determined fuel suppliers by adding said low fuel prices provided by each of said determined fuel suppliers and said determined freight charges; and
generating and transmitting a list of said determined fuel suppliers and said computed resultant fuel price associated with each of said determined fuel suppliers to said fuel price activation system at said each of said fuel stations via said network.

16. The computer implemented system of claim 12, wherein said action management module of said fuel price activation system is configured to perform one or more of:
dynamically activating and displaying said selectively transmitted fuel prices on said one or more display units positioned at said each of said fuel stations, over said network; and
scheduling a refueling of fuel tanks at said each of said fuel stations over said network based on said selectively transmitted fuel prices.

17. The computer implemented system of claim 12, wherein said action management module of said fuel price activation system is further configured to perform:
computing a resultant fuel price for each of a plurality of fuel suppliers at a plurality of geographical locations based on said selectively transmitted fuel prices by adding said selectively transmitted fuel prices provided by each of said fuel suppliers and freight charges involved in transporting fuel to fuel tanks at said each of said fuel stations from said geographical locations of said fuel suppliers based on proximity of said geographical locations of said fuel suppliers to said each of said fuel stations;
selecting a lowest said computed resultant fuel price; and
scheduling delivery of said fuel to said fuel tanks at said each of said fuel stations from a selected one of said fuel suppliers associated with said selected lowest computed resultant fuel price.

18. The computer implemented system of claim 12, wherein said modules of said fuel price activation system further comprise an alert transmission module configured to perform:
transmitting one or more notifications on a low fuel price to said user devices via said network based on predetermined criteria, wherein said predetermined criteria comprise frequency of visitation of users associated with said user devices to said fuel stations, and proximity of said user devices to said fuel stations;
transmitting an alert message to said one or more display units positioned at one or more of a plurality of fuel tanks at said each of said fuel stations via said network to indicate shut down of said each of said fuel stations due to gas spillage at said one or more of said fuel tanks; and
transmitting an alert message to said one or more display units positioned at said fuel tanks via said network to indicate a low fuel level, when said fuel level is low at said fuel tanks.

19. The computer implemented system of claim 12, wherein said action management module of said fuel price activation system is further configured to track a fuel level at each of a plurality of fuel tanks at said each of said fuel stations via said network, wherein said fuel price activation system is configured to communicate with said each of said fuel tanks via said network.

20. A computer program product comprising a non-transitory computer readable storage medium, said non-transitory computer readable storage medium storing computer program codes that comprise instructions executable by at least one processor, said computer program codes comprising:
a first computer program code for dynamically acquiring fuel prices associated with a plurality of geographical locations in real time via a network;
a second computer program code for sorting said dynamically acquired fuel prices based on said geographical locations; and
a third computer program code for selectively transmitting said sorted fuel prices to a fuel price activation system at each of a plurality of fuel stations via said network based on said geographical locations of said fuel stations, for enabling said fuel price activation system to perform one or more of said actions at said each of said fuel stations via said network based on said selectively transmitted fuel prices, wherein said actions comprise one or more of:
dynamically activating and displaying said selectively transmitted fuel prices on said one or more display units positioned at said each of said fuel stations, over said network;
scheduling a refueling of fuel tanks at said each of said fuel stations over said network based on said selectively transmitted fuel prices;
computing a resultant fuel price for each of a plurality of fuel suppliers at a plurality of geographical locations based on said selectively transmitted fuel prices, selecting a lowest said computed resultant fuel price, and scheduling delivery of fuel to said fuel tanks at said each of said fuel stations from a selected one of said fuel suppliers associated with said selected lowest computed resultant fuel price;
transmitting one or more notifications on a low fuel price to said user devices via said network based on predetermined criteria, wherein said predetermined criteria comprise frequency of visitation of users associated with said user devices to said fuel stations, and proximity of said user devices to said fuel stations;
forecasting volume and grade of fuel required at said each of said fuel stations at predetermined time intervals based on said selectively transmitted fuel prices and frequency of visitation of users associated with said user devices to said each of said fuel stations;
transmitting an alert message to said one or more display units positioned at each of one or more of said fuel tanks at said each of said fuel stations via said network to indicate a low said fuel level, when said fuel level is low at said each of said fuel tanks; and
transmitting an alert message to said one or more display units positioned at one or more of said fuel tanks at said each of said fuel stations via said network to indicate shut down of said each of said fuel stations due to gas spillage at said one or more of said fuel tanks.
